(19) United States
(12) Patent Application Publication
(10) Pub. No.: US 2012/0166151 A1
(43) Pub. Date: Jun. 28, 2012

(54) SYSTEM AND METHOD FOR PERFORMANCE MONITORING OF COMMERCIAL REFRIGERATION

(75) Inventors: Radek Fisera, Prague (CZ); Martin Hrncar, Prague (CZ)

(73) Assignee: Honeywell International Inc., Morristown, NJ (US)

(21) Appl. No.: 12/976,088

(22) Filed: Dec. 22, 2010

(51) Int. Cl. G06F 17/10

(52) U.S. Cl. 703/2

(57) ABSTRACT

A process includes measuring internal variables and external variables in a commercial refrigeration system, and calculating a daily aggregate for each of the variables. A local energy consumption model and a long term energy consumption model are created. Daily aggregates that contain an anomaly are removed from the long term energy consumption model before creating the long term energy consumption model. The energy consumption deviation estimated by the local energy consumption model is compared with the energy consumption deviation estimated by the long term energy consumption model. A temporary deviation is detected from the local energy consumption model and/or the long term energy consumption model. A continuously increasing degradation in relation to the long term energy consumption model is detected, and a long term degradation rate is calculated.

### TECHNICAL FIELD

The current disclosure relates to a system and method for monitoring the performance of a commercial refrigeration system.

### BACKGROUND

Energy consumed by supermarkets in the United States represents about 4% of national energy consumption, and out of this energy consumed by supermarkets, more than 50% is consumed by the refrigeration systems of such supermarkets. It would be beneficial then to efficiently control the refrigeration systems of supermarkets and monitor the refrigeration systems' energy consumption, because any even relatively small increase in refrigeration load caused by a fault or degradation has a large impact on the cost of such refrigeration.

Faults typically encountered in supermarket refrigeration systems can be divided into two main groups according to their dynamics—hard faults (e.g., compressor break down, fast refrigerant leak, refrigerant line restrictions) and soft faults (e.g., slow refrigerant leak, equipment aging degradations, condenser fouling, impurities in system). Currently, only energy monitoring tools are deployed in commercial refrigeration (retail) systems. These tools typically directly measure the energy consumed by the refrigeration system and compare it against a predefined threshold. Limits are often also fixed only (i.e., non-adaptive), regardless of other influencing factors, e.g., varying electricity price and varying load driving conditions (weather). These simple energy monitoring tools however can give only very rough and often misleading estimates. While efforts have been made to try to improve these tools by load normalization, the load models are inaccurate and often require too much information, which restricts its deployment. Additionally, while a traditional coefficient of performance (COP) can be used in connection with vapor compression cycle equipment to quantify current system efficiency, it is difficult (and often not possible) to evaluate COP for retail refrigeration systems as the air mass flow rate in the evaporator measurements are not available.

The art is therefore in need of a system and method to monitor the performance of commercial refrigeration systems equipped only with a standard sensor set.

### BRIEF DESCRIPTION OF THE DRAWINGS

FIG. 1 is a flowchart of an example embodiment of a process to monitor the performance of a commercial refrigeration system.

FIGS. 2A and 2B are a flowchart of another example embodiment of a process to monitor the performance of a commercial refrigeration system.

FIG. 3 is a block diagram of an example embodiment of a computer system upon which one or more embodiments of the present disclosure can operate.

### DETAILED DESCRIPTION

One or more embodiments of the current disclosure address the problem of refrigeration system performance assessment, i.e., calculation of an appropriate system-level performance indicator. In this context the ratio between the measured and modeled energy consumption is treated as the performance indicator. An embodiment is based on typically available sensor data at a supermarket, and for a separate refrigeration system (circuit), the overall performance indicator is calculated. The total amperage (daily aggregates) consumed by the supermarket refrigeration system in keeping the goods at a required temperature can be modeled based on selected (aggregated) inputs. Moreover, a selected approach allows simple trending and monetization of observed degradations.

An embodiment includes two main capabilities. It compares measured energy consumption with a model-based baseline, and detects a temporary deviation (anomaly) and/or a continuously increasing deviation (degradation trend). The detection of the deviation and the continuous degradation requires two types of advanced baseline models. Semi-global models (seasonal or long term) are built/identified offline from historical commissioning data (best known behavior) to be able to detect a slowly and continuously increasing deviation from referential energy consumption (caused, for example, by equipment degradation or slow refrigerant leak). This means that healthy (i.e., fault free) data are expected during model identification. Models that are used for energy consumption anomaly detection are built on-the-fly (for each query point) to allow slow (lazy learning) adaptation. This brings the capability of automated adaptation on the intended changes in the energy consumption pattern (control strategy and set point adjustments). These two approaches can be combined to extend the detection capability.

A detected anomaly or a degradation is reported in two ways. First, it can be reported online. In such a case, both models are identified based on historical data only, and current energy consumption is predicted. Detected events are reported in almost real time (with one day delay at maximum). Second, it can be reported offline. Consequently, even data that is newer than a current query point can be used. This approach is suitable, for example, for the generation of on demand reports wherein the energy consumption anomalies can be easily detected in queried intervals from the past.

In comparison to current state of the art products, embodiments herein bring several new functionalities, and have two types of energy base-lining models that differ by the type of desirably detected energy consumption deviation. Models are built automatically from healthy referential data. Fault free data are found by an additional tool (PCA based). Embodiments make use only of commonly installed sensors in the supermarket so that the high deployment ability is achieved.

In a particular mode of operation, selected measures, based on typically available sensor set measures for a supermarket representing internal and external conditions, are collected from a supermarket or other commercial refrigeration system. Other input variables for the model (e.g., calculated mean values and a set of dummy variables) are added. The daily aggregates of all input variables are then calculated. No correlations between daily aggregates are assumed. Before a Global Multivariate Linear Regression Model is identified on a particular training interval (approximately months), the days with anomalies (e.g., failures) must be removed. A Principal Component Analysis (PCA) provides a suitable apparatus for removing the anomalous days. Main measured system variables (temperatures, pressures) are used as the PCA inputs. The training interval (˜days) must cover healthy data. Therefore, the PCA should be trained when the system is in good condition, e.g., after performed maintenance. A properly trained PCA has the capability to register any anomalies via detecting violation of correlation pattern among the main system variables that can signal a fault. The anomaly occurrence influences the value of a Q statistic calculated by the PCA. The Q statistic daily aggregates are calculated, and the days when the aggregated Q statistic exceeds a defined threshold are labeled as days with anomalies. These days are removed from model identification. The model identified on healthy data provides the estimate of daily average energy consumption at given driving conditions. These estimates can be compared to the actual power consumption of the system. If the measured consumption deviates from the predicted one for the same given inputs (driving conditions), an abnormal condition is indicated. Only the deviations outside model confidence bounds are reported. Typically the higher consumption is caused by the system degradation or faulty behavior.

The PCA is also used to signal the day with an anomaly (caused typically by a hard fault) leading often to a high energy consumption increase. Such a day cannot be used for a slow degradation (soft fault) trend estimation because it would distort the desired output, so it must be removed from the prediction interval. The intent is to separate the influence of slow degradations. The degradation rate differs for different load driving conditions, but the trend of prediction error obtained after the anomaly exclusion represents the average degradation rate (averaged over driving conditions encountered in the prediction interval). An estimated degradation trend allows simple calculation of a power consumption increase over the given time period of one refrigeration circuit, and hence allows simple results monetization. An optimum maintenance period can also be easily evaluated if maintenance costs are known. A second branch algorithm (local lazy learning models) targets mainly the anomalies and does not require the removal of the faulty days from the data used for model identification. However, it does require a sufficiently large database of historical data. The influence of the eventual anomalies (outliers) is then automatically (statistically) suppressed assuming that the anomaly is an unusual behavior rarely encountered. It normally provides the prediction with higher accuracy (lower estimate variance).

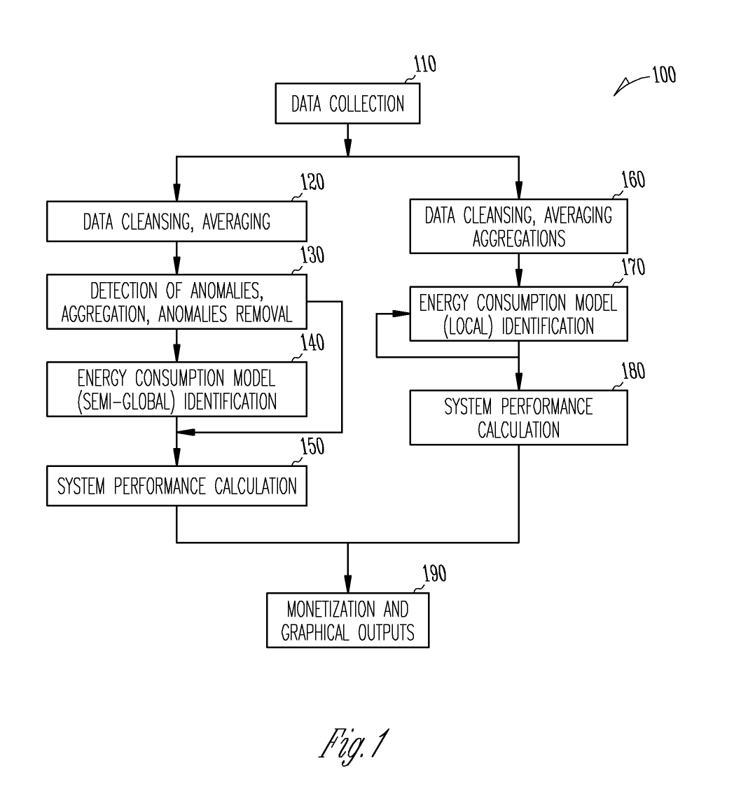

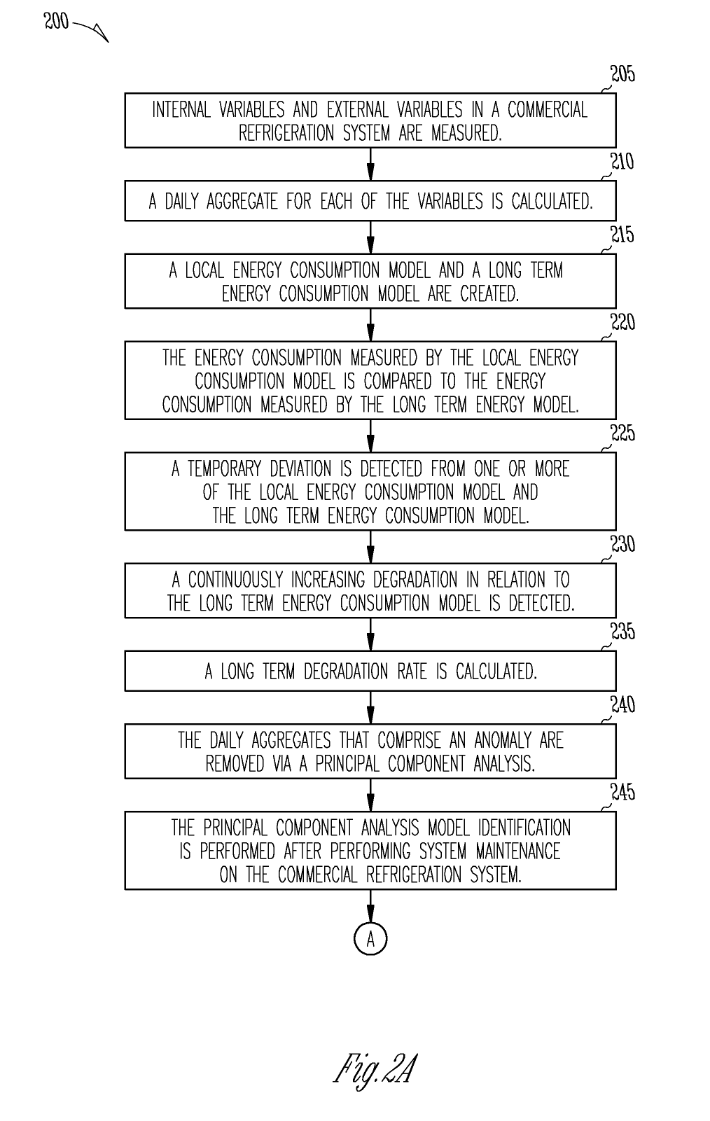

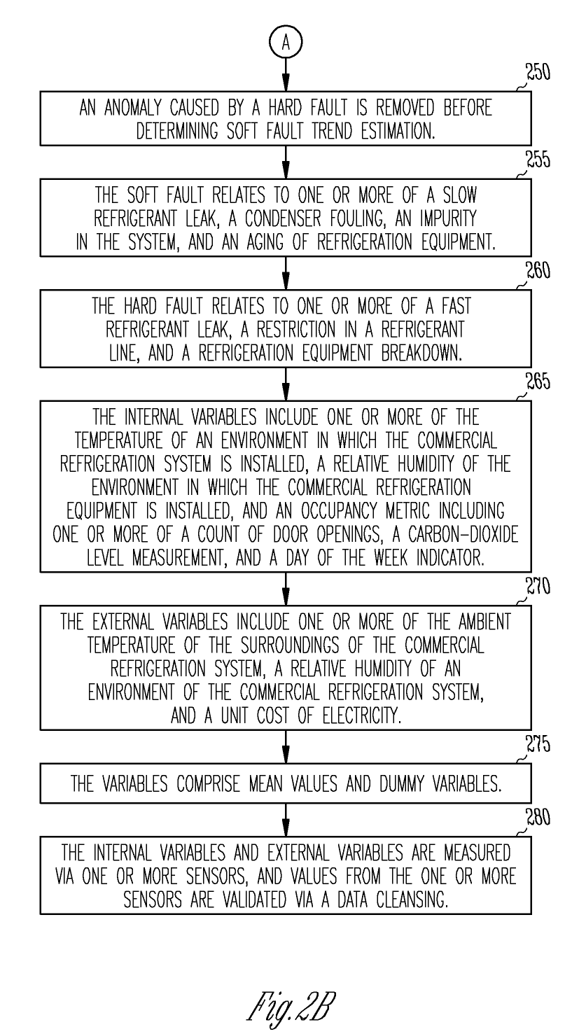

FIGS. 1, 2A, and 2B are flowcharts of example processes 100 and 200 for performance monitoring of a commercial refrigeration system. FIG. 1 includes a number of process blocks 110-190, and FIGS. 2A and 2B includes a number of process blocks 205-280. Though arranged serially in the examples of FIGS. 1, 2A, and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIG. 1, there is a first branch that relates to a semi-global process (120-150), and a second branch that relates to a local process (160-180). Referring to the semi-global branch, data is collected at 110. The data is collected from typical sensors that are used in connection with commercial refrigeration systems. The data is cleansed and averaged at 120. The cleansing of the data involves application of simple methods for removing faulty sensor readings like outliers and frozen sensors from the data. At 130, anomalies are detected and removed, and the remainder of the data is aggregated. The anomalies are detected as explained above. At 140, an energy consumption model (semi-global, e.g., seasonal) is identified, and system performance is calculated at 150. Referring to the local branch, at 160, the data collected from the sensors at 110 is cleansed, averaged and aggregated at 160. At 170, a local energy consumption model is identified (for each query point), and at 180, the performance of the system is calculated. For both the semi-global and the local branches, the system outputs monetization data and graphical outputs at 190.

FIGS. 2A and 2B illustrate an example of a more detailed process 200 to monitor the performance of a commercial refrigeration system. At 205, internal variables and external variables in a commercial refrigeration system are measured. The internal variables and external variables relate to soft faults and hard faults. The measurements are taken from sensors that are normally employed in a commercial refrigeration system. At 210, a daily aggregate for each of the variables is calculated. At 215, a local energy consumption model and a long term energy consumption model are created. For the long term energy consumption model, daily aggregates that contain an anomaly are removed before the long term energy consumption model is created. At 220, the energy consumption deviation estimated by the local energy consumption model is compared to the energy consumption deviation estimated by the long term energy consumption model. At 225, a temporary deviation is detected from one or more of the local energy consumption model and the long term energy consumption model. Exploiting the results from both branches depicted in FIG. 1 enables the discrimination among various causes of the consumption deviation, e.g., between a short term unusual event and a control strategy change. At 230, a continuously increasing degradation in relation to the long term energy consumption model is detected, and at 235, a long term degradation rate is estimated.

At 240, the daily aggregates that comprise an anomaly are removed via a principal component analysis (PCA). At 245, the principal component analysis model identification is performed after performing system maintenance on the commercial refrigeration system. At 250, an anomaly caused by a hard fault is removed (i.e., the day containing faulty data) from query interval before determining soft fault trend estimation. The anomaly can be detected by either a PCA or a local model (however, the output of the latter can additionally be monetized). At 255, the soft fault relates to one or more of a slow refrigerant leak, a condenser fouling, an impurity in the system, and an aging of refrigeration equipment, and at 260, the hard fault relates to one or more of a fast refrigerant leak, a restriction in a refrigerant line, and a refrigeration equipment breakdown. At 265, the internal variables include one or more of the temperature of an environment in which the commercial refrigeration system is installed, a relative humidity of the environment in which the commercial refrigeration equipment is installed, and an occupancy metric including one or more of a count of door openings, a carbon dioxide level measurement, and a day of the week indicator. At 270, the external variables include one or more of the ambient temperature of the surroundings of the commercial refrigeration system, a relative humidity of an environment of the commercial refrigeration system, and a unit cost of electricity. At 275, the variables comprise mean values and dummy variables. The mean values capture average indoor space temperature and humidity, and the dummy variables are for a virtual occupancy sensor that is evaluated from a day of the week. At 280, the internal variables and external variables are measured via one or more sensors, and values from the one or more sensors are validated via a data cleansing.

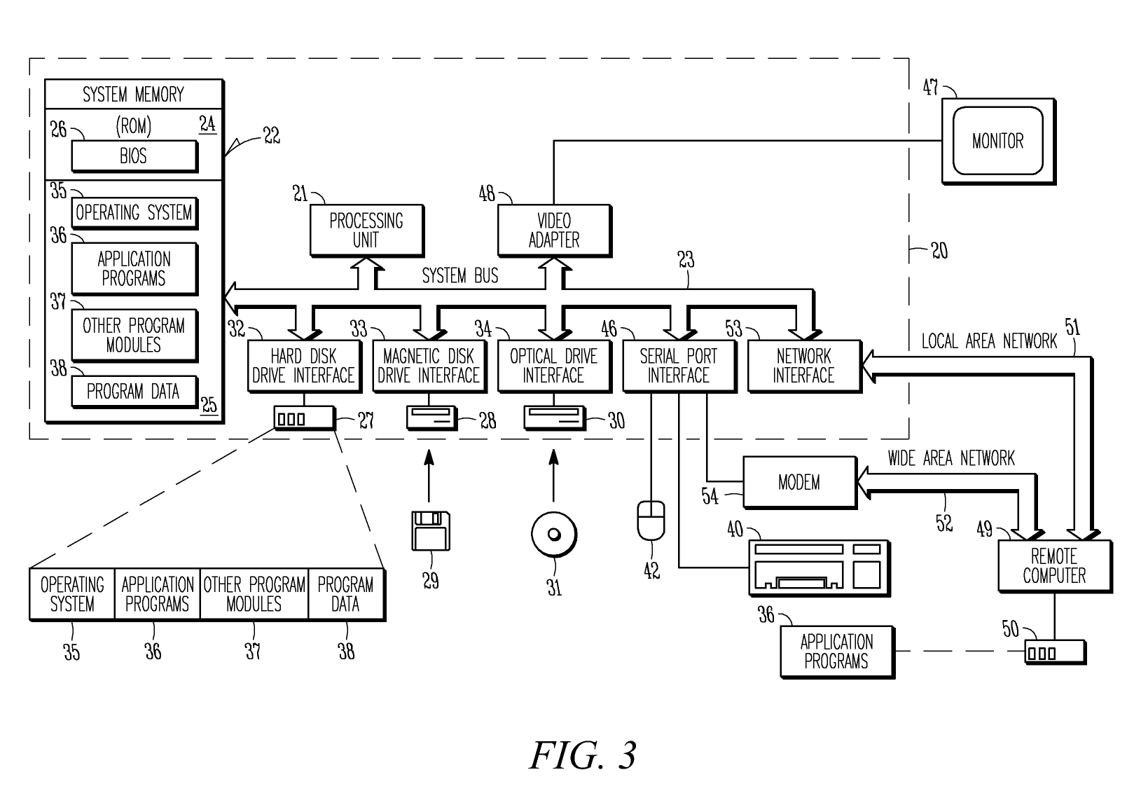

FIG. 3 is an overview diagram of a hardware and operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

1. A process comprising:
measuring internal variables and external variables in a commercial refrigeration system, the internal variables and external variables relating to a soft fault and a hard fault;
calculating a daily aggregate for each of the variables;
creating a local energy consumption model and a long term energy consumption model, wherein the creating the long term energy consumption model comprises removing daily aggregates that contain an anomaly before creating the long term energy consumption model;
comparing measured energy consumption with the local energy consumption model and the long term energy consumption model;
detecting a temporary deviation from one or more of the local energy consumption model and the long term energy consumption model;
detecting a continuously increasing degradation in relation to the long term energy consumption model; and
calculating a long term degradation rate.

2. The process of claim 1, comprising removing the daily aggregates that comprise an anomaly via a principal component analysis (PCA).

3. The process of claim 2, comprising performing the principal component analysis model identification after performing a system maintenance on the commercial refrigeration system.

4. The process of claim 1, comprising removing an anomaly caused by a hard fault before determining a soft fault trend estimation.

5. The process of claim 1, wherein the soft fault relates to one or more of a slow refrigerant leak, a condenser fouling, an impurity in the system, and an aging of refrigeration equipment, and the hard fault relates to one or more of a fast refrigerant leak, a restriction in a refrigerant line, and a refrigeration equipment breakdown.

6. The process of claim 1, wherein the internal variables include one or more of the temperature of an environment in which the commercial refrigeration system is installed, a relative humidity of the environment in which the commercial refrigeration equipment is installed, and an occupancy metric including one or more of a count of door openings, a carbon dioxide level measurement, and a day of the week indicator.

7. The process of claim 1, wherein the external variables include one or more of an ambient temperature of the surroundings of the commercial refrigeration system, a relative humidity of an environment of the commercial refrigeration system, and a unit cost of electricity.

8. The process of claim 1, wherein the variables comprise mean values to capture average indoor space temperature and humidity, and dummy variables for a virtual occupancy sensor evaluated from a day of the week.

9. The process of claim 1, wherein the internal variables and external variables are measured via one or more sensors; and wherein values from the one or more sensors are validated via a data cleansing.

10. A non-transitory computer readable storage medium comprising instructions that when executed by a computer processor execute a process comprising:
measuring internal variables and external variables in a commercial refrigeration system, the internal variables and external variables relating to a soft fault and a hard fault;
calculating a daily aggregate for each of the variables;
creating a local energy consumption model and a long term energy consumption model, wherein the creating the long term energy consumption model comprises removing daily aggregates that contain an anomaly before creating the long term energy consumption model;
comparing measured energy consumption with the local energy consumption model and the long term energy consumption model;
detecting a temporary deviation from one or more of the local energy consumption model and the long term energy consumption model;
detecting a continuously increasing degradation in relation to the long term energy consumption model; and
calculating a long term degradation rate.

11. The computer readable medium of claim 10, comprising instructions for:
removing the daily aggregates that comprise an anomaly via a principal component analysis (PCA); and
performing the principal component analysis model identification after performing a system maintenance on the commercial refrigeration system.

12. The computer readable medium of claim 10, comprising instructions for removing an anomaly caused by a hard fault before determining a soft fault trend estimation.

13. The computer readable medium of claim 10, wherein the soft fault relates to one or more of a slow refrigerant leak, a condenser fouling, an impurity in the system, and an aging of refrigeration equipment, and the hard fault relates to one or more of a fast refrigerant leak, a restriction in a refrigerant line, and a refrigeration equipment breakdown.

14. The computer readable medium of claim 10, wherein the internal variables include one or more of the temperature of an environment in which the commercial refrigeration system is installed, a relative humidity of the environment in which the commercial refrigeration equipment is installed, and an occupancy metric including one or more of a count of door openings, a carbon dioxide level measurement, and a day of the week indicator; and wherein the external variables include one or more of the ambient temperature of the surroundings of the commercial refrigeration system, a relative humidity of an environment of the commercial refrigeration system, and a unit cost of electricity.

15. The computer readable medium of claim 10, wherein the variables comprise mean values to capture average indoor space temperature and humidity, and dummy variables for a virtual occupancy sensor evaluated from a day of the week.

16. The computer readable medium of claim 10, wherein the internal variables and external variables are measured via one or more sensors; and wherein values from the one or more sensors are validated via a data cleansing.

17. A system comprising:
one or more computer processors configured for:
measuring internal variables and external variables in a commercial refrigeration system, the internal variables and external variables relating to a soft fault and a hard fault;
calculating a daily aggregate for each of the variables;
creating a local energy consumption model and a long term energy consumption model, wherein the creating the long term energy consumption model comprises removing daily aggregates that contain an anomaly before creating the long term energy consumption model;
comparing measured energy consumption with the local energy consumption model and the long term energy consumption model;
detecting a temporary deviation from one or more of the local energy consumption model and the long term energy consumption model;
detecting a continuously increasing degradation in relation to the long term energy consumption model; and
calculating a long term degradation rate.

18. The system of claim 17, comprising one or more computer processors configured for:
removing the daily aggregates that comprise an anomaly via a principal component analysis (PCA);
performing the principal component analysis model identification after performing a system maintenance on the commercial refrigeration system; and
removing an anomaly caused by a hard fault before determining a soft fault trend estimation.

19. The system of claim 17, wherein
the soft fault relates to one or more of a slow refrigerant leak, a condenser fouling, an impurity in the system, and an aging of refrigeration equipment;
the hard fault relates to one or more of a fast refrigerant leak, a restriction in a refrigerant line, and a refrigeration equipment breakdown;
the internal variables include one or more of the temperature of an environment in which the commercial refrigeration system is installed, a relative humidity of the environment in which the commercial refrigeration equipment is installed, and an occupancy metric including one or more of a count of door openings, a carbon dioxide level measurement, and a day of the week indicator;
the external variables include one or more of the ambient temperature of the surroundings of the commercial refrigeration system, a relative humidity of an environment of the commercial refrigeration system, and a unit cost of electricity; and
the variables comprise mean values to capture average indoor space temperature and humidity, and dummy variables for a virtual occupancy sensor evaluated from a day of the week.

20. The system of claim 17, wherein the internal variables and external variables are measured via one or more sensors; and wherein values from the one or more sensors are validated via a data cleansing.
